(19) United States
(12) Patent Application Publication
(10) Pub. No.: US 2026/0128766 A1
(43) Pub. Date: May 7, 2026

(54) FEEDBACK TRANSMISSIONS FOR SPATIALLY COUPLED MULTIPLE-INPUT MULTIPLE-OUTPUT COMMUNICATIONS

(71) Applicant: QUALCOMM Incorporated, San Diego, CA (US)

(72) Inventors: Kirill IVANOV, La Jolla, CA (US); Wei YANG, San Diego, CA (US); Jing JIANG, San Diego, CA (US); Jing SUN, San Diego, CA (US); Hari SANKAR, San Diego, CA (US)

(21) Appl. No.: 18/936,714

(22) Filed: Nov. 4, 2024

(51) Int. Cl. H04B 7/0413; H04W 72/115

(52) U.S. Cl. CPC H04B 7/0413; H04W 72/115

(57) ABSTRACT

Aspects of the present disclosure relate to wireless communications, and more particularly, to techniques for multiple-input multiple-output (MIMO) communications. One example method generally includes: receiving a signal using a MIMO receiver, wherein the signal includes a plurality of code blocks (CBs), each of the plurality of CBs including a first part received via a first layer of the MIMO receiver and a second part received via a second layer of the MIMO receiver, wherein the second part of each of the plurality of CBs is shifted within a spectrum by at least one resource position with respect to the first part of each of the plurality of CBs; transmitting an indication of one or more CBs of the plurality of CBs that have failed decoding at the UE; and receiving a retransmission signal including at least the one or more CBs that have failed the decoding at the UE.

### FIELD OF THE DISCLOSURE

Aspects of the present disclosure relate to wireless communications, and more particularly, to techniques for multiple-input multiple-output (MIMO) communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes receiving a signal using a multiple-input multiple-output (MIMO) receiver, wherein the signal includes a plurality of code blocks (CBs), each of the plurality of CBs including a first part received via a first layer of the MIMO receiver and a second part received via a second layer of the MIMO receiver, wherein the second part of each of the plurality of CBs is shifted within a spectrum by at least one resource position with respect to the first part of each of the plurality of CBs; transmitting an indication of one or more CBs of the plurality of CBs that have failed decoding at the UE; and receiving a retransmission signal including at least the one or more CBs that have failed the decoding at the UE.

Another aspect provides a method for wireless communication at a network entity. The method includes transmitting, to a UE a signal using a MIMO transmitter, wherein the signal includes a plurality of CBs, each of the plurality of CBs including a first part transmitted via a first layer of the MIMO transmitter and a second part transmitted via a second layer of the MIMO transmitter, wherein the second part of each of the plurality of CBs is shifted within a spectrum by at least one resource position with respect to the first part of each of the plurality of CBs; receiving an indication of one or more CBs of the plurality of CBs that have failed decoding; and transmitting a retransmission signal including at least the one or more CBs that have failed the decoding.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts example transmit processing for multiple-input multiple-output (MIMO) communications with shaping, in accordance with certain aspects of the present disclosure.

FIG. 6A depicts a dual-code word (CW) multiple-input multiple-output (MIMO) structure.

FIG. 6B depicts a single-CW MIMO structure.

FIGS. 7A and 7B illustrate a structure that allows for successive cancellation (SIC), in accordance with certain aspects of the present disclosure.

FIG. 8 depicts a call flow diagram for MIMO communications with feedback, in accordance with certain aspects of the present disclosure.

FIG. 9 depicts a method for wireless communications.

FIG. 10 depicts a method for wireless communications.

FIG. 11 depicts aspects of an example communications device.

FIG. 12 depicts aspects of an example communications device.

### DETAILED DESCRIPTION

Certain aspects of the present disclosure are directed toward a hybrid-automatic request (HARQ) operations for spatially coupled (SC)-multiple-input multiple-output (MIMO) communications. When using SC-MIMO, a signal for transmission may include a first code block (CB) with at least two parts, where one part of the first CB is cyclically shifted by at least one position from another part of the CB. The parts of the first CB may be transmitted and received using different layers of a MIMO transmitter and receiver. The signal may also include a head CB to be transmitted on one or more of the layers of the MIMO transmitter. The design structure facilitates successive interference cancellation (SIC) at a receiver. As used herein, interference cancellation generally refers to any process used to at least reduce interference with a CB before decoding. Certain aspects of the present disclosure provide techniques for hybrid-automatic request (HARQ) operations which may involve the receiver indicating one or more CBs that have failed decoding. The transmitter may respond with a grant of resources for a retransmission that may include the one or more CBs that have failed decoding, and in some cases, one or more additional CBs depending on the retransmission scheme to be used. In some cases, the retransmission scheme may be selected based on reporting capabilities of the receiver, as described in more detail herein.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

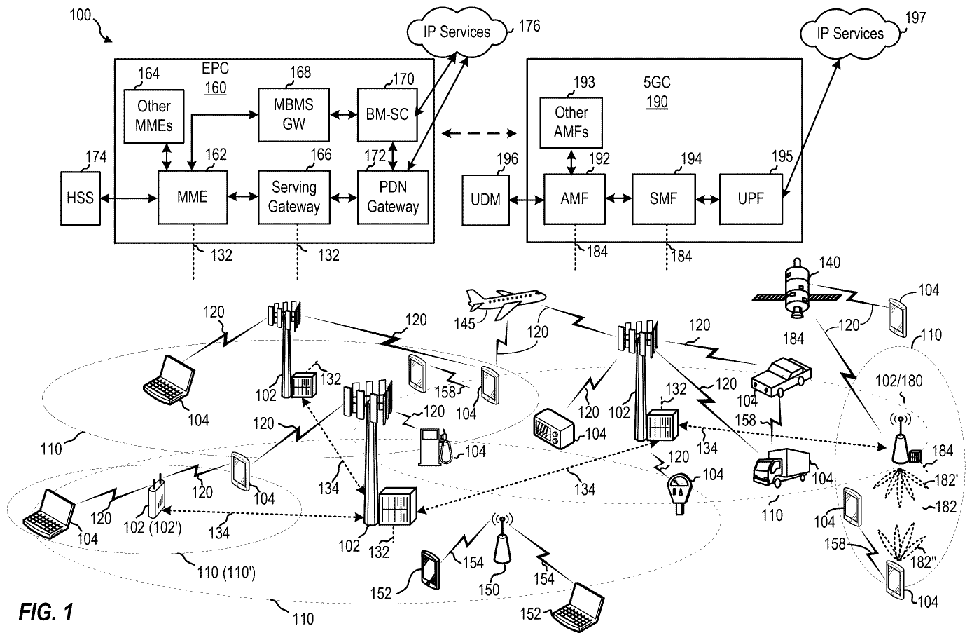

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

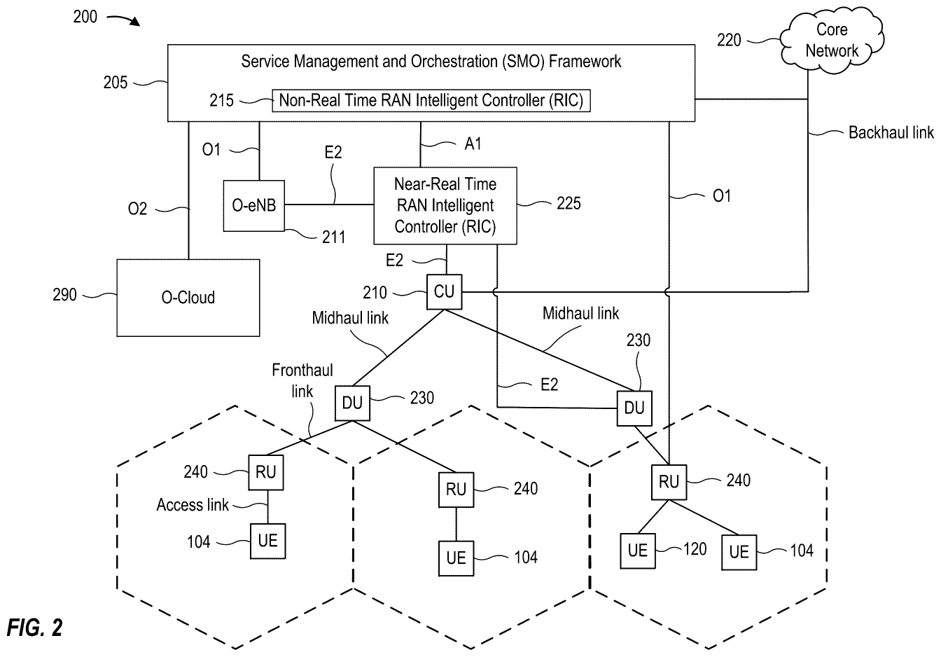

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-cNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

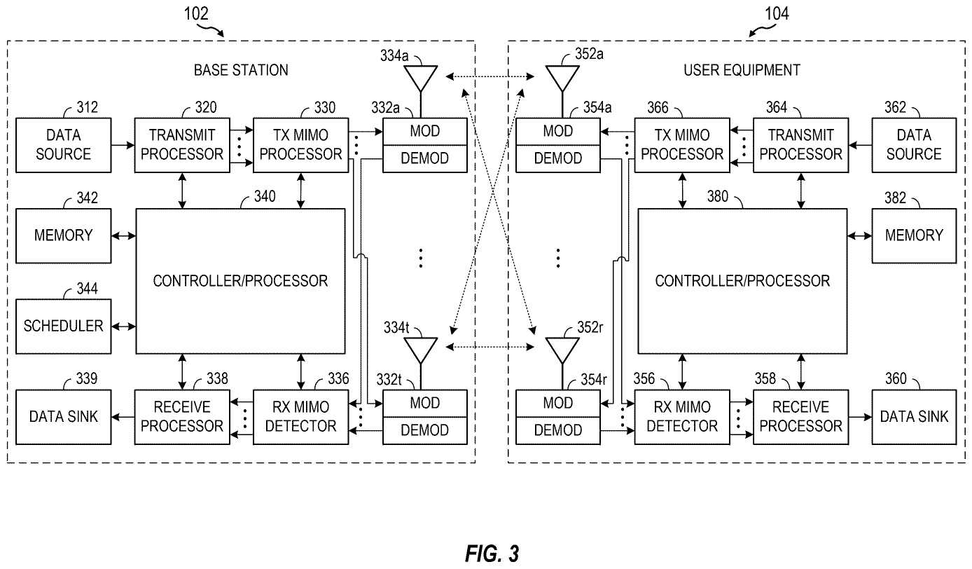

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

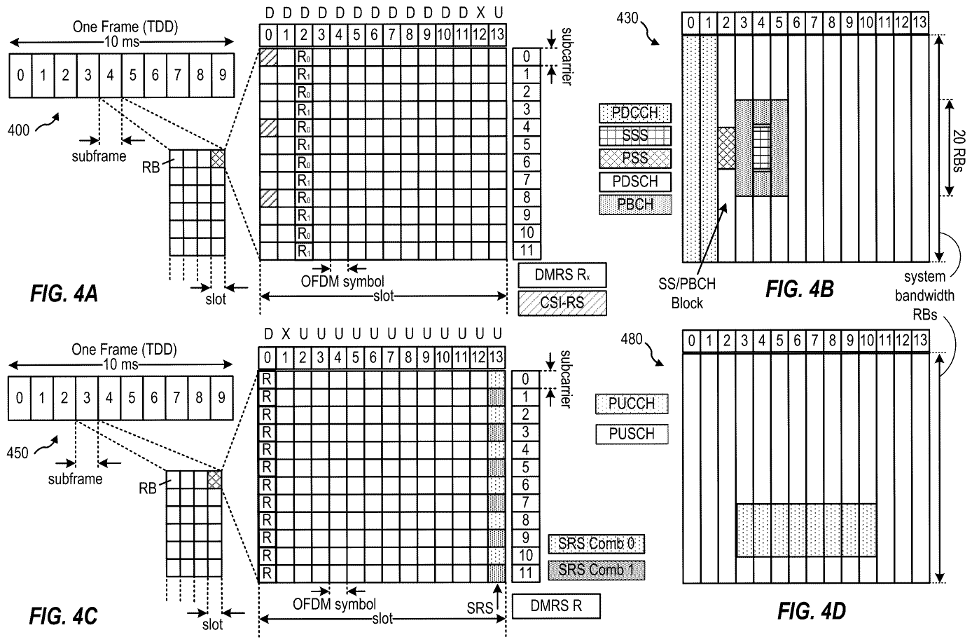

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Probabilistic Shaping

Communication over a channel is possible if the transmission rate over the channel satisfies a capacity based on the transmission power and the signal-to-noise ratio (SNR). The Shannon Capacity refers to a theorem that defines a maximum amount of information that can be transmitted over a channel (e.g. a wireless channel). Traditionally used coded modulation (CM) techniques, such as amplitude shift keying (ASK) and quadrature amplitude modulation (QAM), have signal constellations that are characterized by equidistant signal points and uniform signaling (e.g., a non-Gaussian distribution of information), meaning each signal point is transmitted with a same probability. Unfortunately, uniform signaling may optimistically achieve an achievable information rate (AIR) that is 1.53 dB (0.255 bits per dimension (bit/1-D)) away from the capacity of the AWGN channel (sometimes referred to as the “shaping gap”).

To close the shaping gap and to increase spectral efficiency, signal shaping techniques may be applied to generate a non-uniform distribution of the information. For example, in geometric shaping, constellation points are arranged in the complex plane in a non-equidistant manner to mimic a capacity achieving distribution. Probabilistic shaping, on the other hand, starts with a constellation with equidistant signal points (e.g., ASK or QAM) but assigns different probabilities to different constellation points.

In existing wireless communication standards (e.g., cellular and WiFi), higher-order modulation (e.g., 16-QAM, 64-QAM, or 256-QAM) are used to increase the spectral efficiency at higher SNR values.

In a typical QAM-based transmission processing flow, an information payload (e.g., K information bits) may be encoded, with channel coding to generate a set of coded bits. The actual bit stream after channel encoding may not be uniformly distributed. As such, a scrambling technique may be used to scramble the coded bits after the encoder with some uniform random bits. Uniform distributed bits implies that the modulation symbols after modulation are uniformly distributed over the constellation set.

In conventional systems, the constellations are fixed (typically square constellations as with the 16-QAM constellation), and each constellation point is used with equal probability. Probabilistic shaping generates non-uniformly distributed coded modulation symbols and is typically used to improve the spectral efficiency of the coded modulation. The main goal of probabilistic shaping is typically to generate non-uniformly distributed constellations. This can achieve larger mutual information than conventional uniformly distributed constellations at the same SNR. Examples of probabilistic shaping include probabilistic amplitude shaping (PAS), which shapes the amplitude of the constellation, but leaves the sign of the constellation uniformly distributed. Probabilistic shaping is also known as distribution matching (DM).

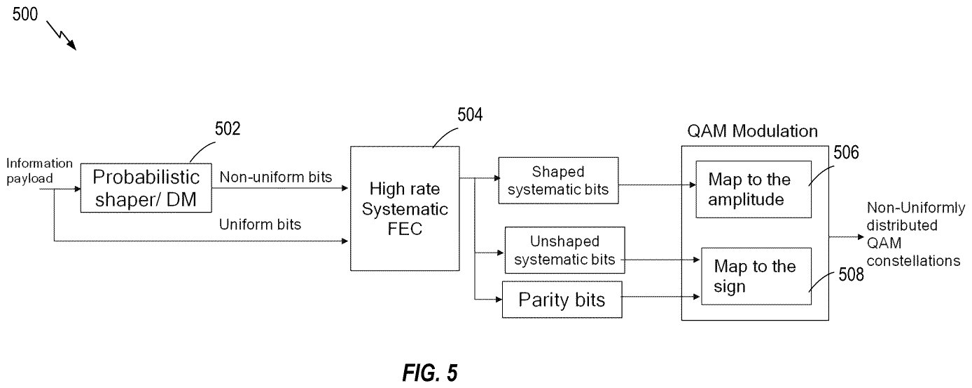

In an example transmitter processing flow 500 illustrated in FIG. 5, a probabilistic shaper (block 502) precedes forward error correction (FEC) coding (block 504). A portion of information payload (I/P) bits is received by the probabilistic shaper, which generates non-uniform bits. A portion of the I/P bits may bypass the probabilistic shaper as uniform bits. The FEC encoder may take the non-uniform bits and uniform bits and generate shaped systematic bits, unshaped systematic bits, and parity bits. These bits are mapped to quadrature amplitude modulation (QAM) symbols by an amplitude mapping component 506 and sign mapping component 508. Resulting QAM symbols are then transmitted over the wireless medium to a wireless receiver.

At the wireless receiver, complementary processing may be performed (in reverse order). The wireless receiver may receive the shaped symbols from the transmitter and perform physical layer processing to recover a sequence of bits corresponding to the original information payload (I/P).

As described above, probabilistic shaping may involve the generation of non-uniformly distributed constellations, which can achieve a larger mutual information I(X;Y) than uniformly distributed constellations at the same SNR. For example, given k information bits, n₁>k bits b₁, . . . , bₙ_{₁} may first be generated through shaping/distribution matching, such that, H_{b}(b₁, . . . , bₙ_{₁})=k. The n₁ shaped bits may then be encoded with a channel code (e.g., low-density parity check-LDPC) to generate n coded bits. The overall rate of the scheme is thus Rₒᵥₑᵣₐₗₗ=R_{FEC}·R_{shaping}.

There are potential issues with probabilistic shaping. For example, only systematic bits can be shaped, which may place a lower bound on coding rate:

$${R}_{FEC} \geq \frac{m - 1}{m}$$

for 2^{m}-PAM modulation (or 2^{2m}-QAM). Very high coding rate may be a drawback in MIMO channels.

### Aspects Related to Spatially Coupled Multiple-Input Multiple-Output Communications

Certain aspects of the present disclosure are directed towards a structure of a spectrum for spatially coupled (SC) multiple-input multiple-output (MIMO) communications. A MIMO transmitter or receiver may be implemented with multiple layers. A layer may refer to a data stream, and each data stream may be transmitted and received via one of multiple antennas used to implement a MIMO transmitter or receiver. For MIMO, at least two layers may be used and the number of layers may be less than or equal to the number of antennas. In some cases, MIMO may be implemented using a single-code word (CW) or a dual-CW implementation. During transmission, a transport block (TB) may include one or more CWs, where each of the CWs may be subsequently segmented into code blocks (CBs).

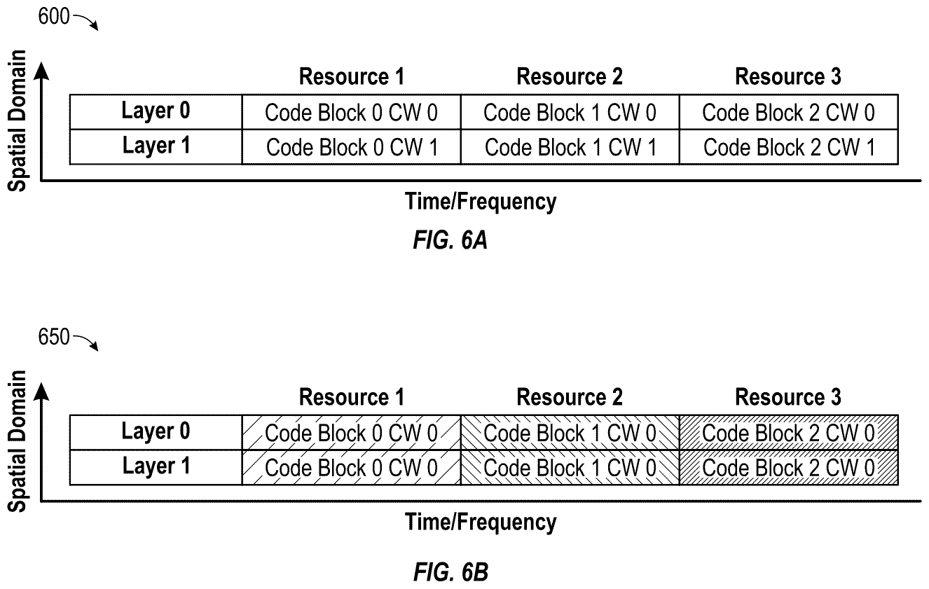

FIG. 6A illustrates a dual CW MIMO design structure 600. The design structure is implemented within a time/frequency spectrum. As used herein, a spectrum refers to resources within time and/or frequency domain, and in some cases, within a spatial domain, as shown. The spectrum may include various resources in the time and/or frequency domain as shown. For example, CW0 and CW1 for CB0 may be transmitted via layer 0 and layer 1 using first time and/or frequency resource (e.g., referred to as “Resource 1”), respectively, followed by CW0 and CW1 for CB1 transmitted via layer 0 and layer 1 using second time and/or frequency resource (e.g., referred to as a “Resource 2”) and so on. Each resource may represent any suitable time and frequency resource. For example, each resource may include less than or more than one OFDM symbol. The resources (e.g., Resource 1 and Resource 2) may represent the same number of resources. For example, each of the resources may be two OFDM symbols. CW0 and CW1 may be assigned different rates. Each resource may be referred to herein as a resource position within the spectrum.

In some aspects, successive interference cancellation (SIC) may be applied to facilitate decoding of CBs. SIC is a technique that may be used by a receiver that allows the decoding of two or more CBs that have been received at least partly simultaneously. For example, a part of a first CB may interfere with a part of a second CB. Once the first CB is decoded, the first CB may be reencoded and subtracted from a signal including the second CB to reduce interference for decoding the second CB. For example, a stronger CB (e.g., a CB transmitted with improved channel conditions, which may be referred to as a “head CB”) may be decoded first, reencoded, and the reencoded CB may be subtracted from the signal to reduce interference from the CB before decoding the other CB.

FIG. 6B illustrates a single CW design structure 650. In some cases, an irregular low-density parity check (LDPC) may be used. LDPC is a linear error correction code used to transmit a message over a noisy transmission channel. In some implementations, iterative demodulation and decoding across the two layers may be performed to increase decoding performance.

In some cases, a single CW design with spatial coupling (SC), referred to as a diagonal BLAST type (or D-BLAST), may be used where BLAST stands for “Bell Laboratories Layered Space-Time.” In this case, a single CW rate is selected to match the collective channel quality across multiple layers.

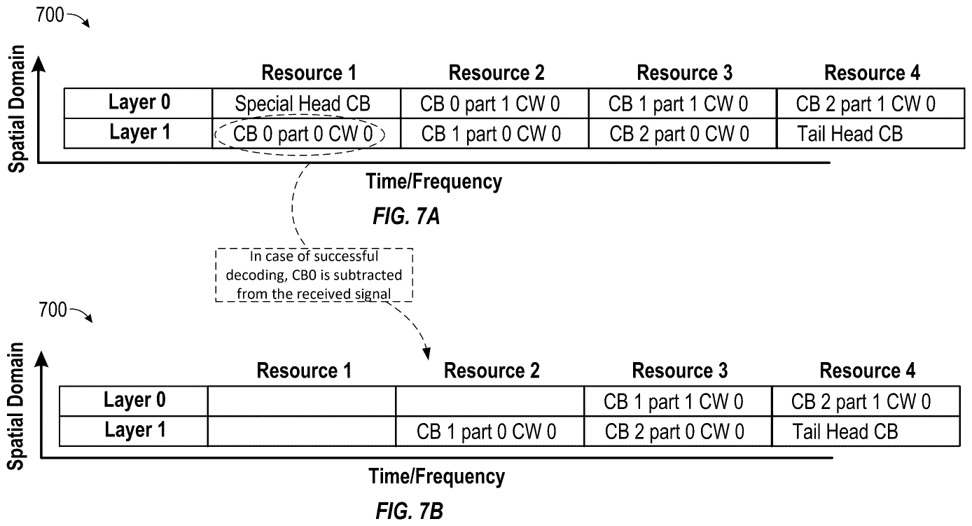

FIG. 7A illustrates an example SC-MIMO technique including a code structure 700 implemented for a codeword (CW0) that may be designed to capture more channel realizations. As shown, each CB may include at least two parts, where one part (e.g., part 0) of the CB (e.g., CB0) is shifted in the spectrum by at least one resource position with respect another part (e.g., part 1) of the CB, and the different parts are transmitted using different layers. For example, as shown, CB0 part 0 may be in resource 1 and transmitted on layer 1 and CB0 part 1 may be in resource 2 and transmitted on layer 0. Thus, CB0 part 1 is shifted in the spectrum by one resource position with respect to CB0 part 0. The shifting of the CB parts in the spectrum facilitate successive interference cancellation (SIC) to capture more channel realizations. SIC may be performed at the receiver side. In the illustrated example, CB0 (e.g., including part 0 and part 1 of CB0) is demodulated and decoded first. In the case of successful decoding, CB0 reencoded and subtracted from the received signal, and then CB1 is demodulated and decoded. Similarly, in case of successful decoding, CB1 is subtracted from the received signal and CB 2 is demodulated and decoded. This procedure may be repeated until all CBs are successfully decoded or CB decoding failure is declared.

Rate loss may be alleviated by introducing a special head CB that is easier to decode (e.g., has a lower MCS and/or higher transmit Tx power), as shown. SIC may be applied to facilitate decoding of CBs. As described, a part of a first CB may interfere with a part of a second CB. Once the first CB is decoded, the first CB may be reencoded and subtracted from a signal including the second CB to reduce interference for decoding the second CB. A stronger CB (e.g., a CB transmitted with improved channel conditions, which may be referred to as a “head CB”) may be decoded first, reencoded, and the reencoded CB may be subtracted from the signal to reduce interference. In some aspects, the structure 700 may also include a tail CB as shown. A head CB may be decoded first, and a tail CB may be decoded at the end of the decoding process. A head CB generally refers to any CB that is decoded first in time among the CBs, and in some cases, may be transmitted in a manner that provides improved channel conditions (e.g., transmitted with higher power and/or lower modulation and coding scheme (MCS)). A tail CB generally refers to any CB that is decoded last in time among the CBs. Certain aspects are directed towards techniques for providing hybrid-automatic request (HARQ)-acknowledgment (ACK) feedback. In some cases, separate ACK/negative ACK (NACK) reporting for special head/tail CBs and regular CBs may be used.

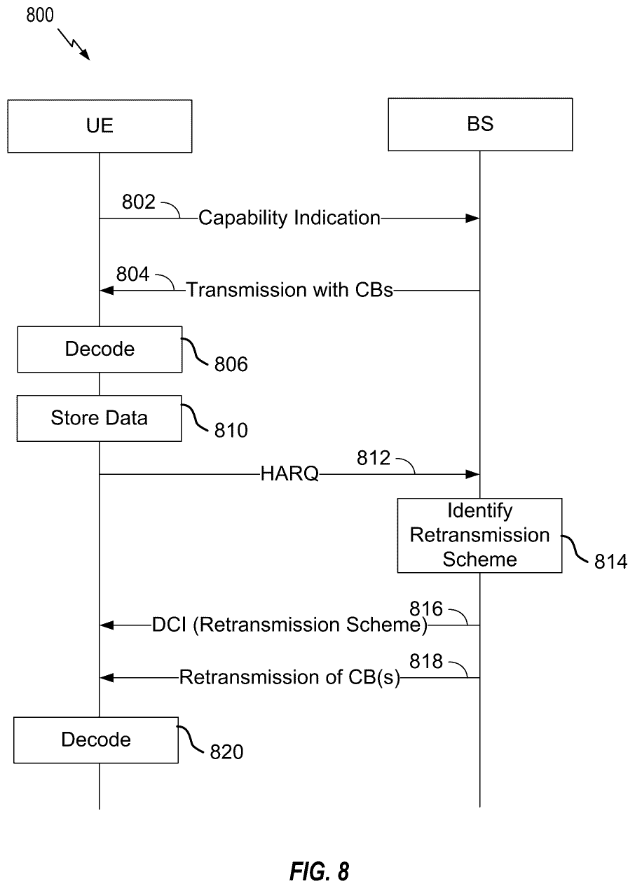

FIG. 8 is a timing diagram illustrating example operations 800 for HARQ retransmission, in accordance with certain aspects of the present disclosure. As shown, a UE may transmit capability information 802 to a base station (BS). As described in more detail herein, the capability information 802 may indicate supported HARQ schemes by the UE.

The BS may transmit a signal including CBs 804 to the UE. At block 806, the UE may attempt to decode the CBs 804, but one or more of the CBs may fail decoding. In some cases, at block 810, the UE may store data associated with the decoding attempt at block 806. For example, as will be described in more detail herein, the UE may store the raw data associated with the signal including the CBs 804 as received, wherein the stored data is to be used for decoding after a retransmission. The UE may transmit HARQ information 812 indicating one or more of the CBs that have failed to decode. In some cases, as part of the HARQ information 812, a failed CB index may be reported by the UE.

At block 814, the BS may identify a retransmission scheme to be used based on the UE's capabilities, as described in more detail herein. The BS may transmit downlink control information (DCI) 816, providing a grant of resources for the retransmission. In some aspects, the DCI may also indicate the retransmission scheme to be used and indices of one or more CBs to be retransmitted. The BS may then retransmit one or more CBs 818 (e.g., corresponding to the one or more CBs that failed decoding) as part of a retransmission signal in accordance with the retransmission scheme. The UE may, at block 820, perform decoding using the retransmission of the CBs, and in some cases, the data stored at block 810.

In some cases, CBs may be decoded from different sides. For example, when performing decoding from one side, the decoder may first decode CB0 and perform SIC based on the decoding of CB0 to decode CB1, followed by CB2. When performing the decoding from another side, a decoder may first decode CB2 and perform SIC based on the decoding of CB2 to decode CB1, followed by CB0. In case of decoding from two-sides, two failed CB indices (e.g., one from each side) may be identified and reported. For example, assume the UE decodes CB0 and fails to decode CB1, and then the UE decodes CB4 and fails to decode CB3. The UE may indicate that CB1 and CB3 have failed decoding. As described in more detail herein, the BS may retransmit either the failed CBs (CB1 and CB3), or the failed CBs along with one or more subsequent CBs such as CB2.

Assuming that a UE is able to feedback the index of the failed CB(s), in some aspects, for a HARQ transmission scheduled with SC-MIMO, the retransmission schemes may include the network transmitting only the failed CB or CBs. For example, as described in the case of decoding from two sides, two failed CB indices (e.g., one from each side) may be reported such as CB1 and CB3. The BS may retransmit the failed CBs only (e.g., CB1 and CB3). This option may be suitable if the UE can store the received signal and channel, so that the UE can resume the SIC when the failed CBs are successfully decoded after HARQ combining. That is, by storing the received signal and channel, the UE can continue decoding CB2 using the stored signal after receiving the retransmission.

In some aspects, the network may transmit the failed CB and all subsequent CBs. For example, if the UE decodes CB0, but fails to decode CB1, the network may retransmit CB1 to CBn−1, n being a positive integer representing the total number of CBs. In some aspects, in case of decoding from two sides, two failed CB indices (e.g., one from each side) may be reported, such as CB1 and CB3. The BS may retransmit the failed CBs (CB1 and CB3), as well as CB2 between CB1 and CB3. This option may be suitable for allowing the UE to continue the demodulation of subsequent CBs (e.g., CB2) after one or more CBs (e.g., CB1 and CB3) fail decoding. In this case, the UE may store the log-likelihood ratios (LLRs) derived for the failed CBs (e.g., CB1 and CB3), but likely stop decoding subsequent CBs (e.g., CB2) and wait for retransmissions. A receiver for a communication system may calculate a LLR from a received signal in a decoding process, and perform iterative decoding depending on the calculated LLR, thereby improving decoding reliability. The LLR may provide a probability value as prior information for the next decoding in the iterative decoding process.

For both options, the network (e.g., base station) may indicate the index of the retransmitted CBs in the retransmission grant. That is, the network may transmit downlink control information (DCI) granting resources for the retransmission of the CB(s), where the DCI includes the index of the CB(s) to be retransmitted. The CB index indication may be either the starting CB index (e.g., indicating that all subsequent CBs will be retransmitted) or the indices of all retransmitted CBs. In the latter case, the network may indicate the starting and ending CB index for the retransmission. For instance, the network may indicate the indices for CB1 and CB3, implying that CB2 will also be transmitted.

Certain aspects are directed toward a layer mapping scheme for HARQ retransmission. The layer mapping scheme to be used may depend on the retransmission scheme. For example, if only the failed CB is transmitted in the HARQ retransmission, the retransmission may be scheduled with regular MIMO (e.g., no SC-MIMO since there is only 1 CB). In other words, instead of using an SC-MIMO technique as described with respect to FIGS. 7A and 7B, the CB may transmitted using the structure 600 of FIG. 6A, but with only one CB.

Even if the UE falls back to regular MIMO, the UE may continue to perform SIC to decode subsequent CBs. For example, the UE may decode and generate LLRs for the retransmitted CB (e.g., which may optionally be combined with previously generated LLR for the failed CB prior to the retransmission). Once the failed CB is decoded, the CB may be reencoded and subtracted from the received signal to decode the subsequent CB (e.g., assuming the UE stored the raw data to continue decoding).

In case more than one CB is retransmitted in the HARQ retransmission, the MIMO layer mapping scheme for the retransmission associated with an SC-MIMO initial transmission may be determined. As a first option, CBs may be retransmitted using regular MIMO. As a second option, the network may use SC-MIMO for the retransmission. In this case, the network may determine what information to include in the special CB. For instance, the network may include data associated with the failed CB in the special CB (e.g., to increase the likelihood that the failed CB is decoded after retransmission and increase reliability). The network may include no data (e.g., provide an empty signal) in the special CB resource position. In some cases, the network may include new data in the special CB (e.g., in order to increase throughput). In some aspects, the network may dynamically indicate whether the retransmission of CBs is via regular MIMO or using SC-MIMO retransmission (e.g., including what information is included in the header CB).

Certain aspects of the present disclosure are directed toward UE decode/demodulation schemes. When the decoding of a CB fails in SC-MIMO, the UE may store the raw channel and data samples for all the subsequent CBs. After receiving the HARQ retransmission and decoding the failed CBs (e.g., with HARQ combining), the UE may resume the SIC on the stored data and channel samples.

In some aspects, the UE may continue the demodulation to generate the LLRs on the subsequent CBs. The UE may fall back to demodulation for regular MIMO (e.g., using linear minimum mean square error (LMMSE) or non-linear demodulation). In this case, the BS may retransmit all CBs from the failed CB and onwards (e.g., since the original channel transmission quality may not be suitable for decoding using LMMSE or non-linear demodulation).

In some cases, the UE may use SIC to demodulate the subsequent CBs. However, the SIC may be based on the hard decision of the channel LLRs from the demodulation of the interference layers, without using decisions from the channel decoding.

The LLR is a measure that compares how likely it is that a particular bit (0 or 1) was sent, given the received signal. If the LLR is positive, it suggests that the received signal is more likely to correspond to a ‘1’. If the LLR is negative, the LLR suggests a ‘0’. In a hard decision, the bit value may be decided based on whether the LLR value is less than 0 or greater than or equal to 0. Hard decisions may be used as a straightforward and computationally less intensive process to identify likely bit values. Hard decisions are less reliable than soft decisions that take into account the degree of confidence in the LLR rather than just making a binary choice. Thus, the CB decoding may be performed using hard decisions in order to perform SIC for subsequent CBs.

In some aspects, the UE may report, to the network, capabilities related to SC-MIMO HARQ retransmission schemes, which may be taken into account when the network determines (e.g., at block 814 of FIG. 8) the scheme to be used for retransmission. The UE may report whether the UE is capable of storing received samples and channel data (e.g., raw data) or just the LLRs. That is, if the UE is able to store the raw data, the UE may resume the SIC on the stored raw data as described. If the UE is only able to store the LLRs, the UE may fall back to regular MIMO after the retransmission or use SIC to demodulate the subsequent CBs, but using the hard decision of the channel LLRs.

If the UE is able to store the raw data, the UE may also report the parameters related to the available buffer size (e.g., buffering capability) for storing the received samples and channel data, such as the number of supported HARQ processes. The greater than number of HARQ processes that are supported, the larger the buffer size that the UE supports. This is a different buffer capability as storing HARQ LLRs since storing received samples (raw data) may involve larger buffer sizes. The UE may be capable of supporting both schemes, reporting the buffer peak throughput or number of HARQ processes.

In some aspects, the capability information may be tailored to not reveal the UE's buffering and reception strategy. For example, the capability information may indicate whether or not the UE is capable to continue to decode subsequent CBs when only a failed CB is retransmitted by the transmitter. In other words, the UE may report whether the UE supports one or more HARQ schemes, such as a HARQ scheme where the network only transmits failed CB(s), or a HARQ scheme where the network transmits the failed CB(s) and all subsequent CBs. In some aspects, the capability information may indicate the supported layer mappings scheme for retransmission, such as whether the UE supports SC-MIMO only or whether the UE also supports regular MIMO. In some aspects, the capability information may indicate whether the UE is capable of decoding SC-MIMO from both sides, or whether the UE is able to decode SC-MIMO only from one side. As described with respect to FIG. 8, the capability information indicated by the UE may be used by the BS to identify a retransmission scheme to use for retransmitting CB(s).

### Example Operations

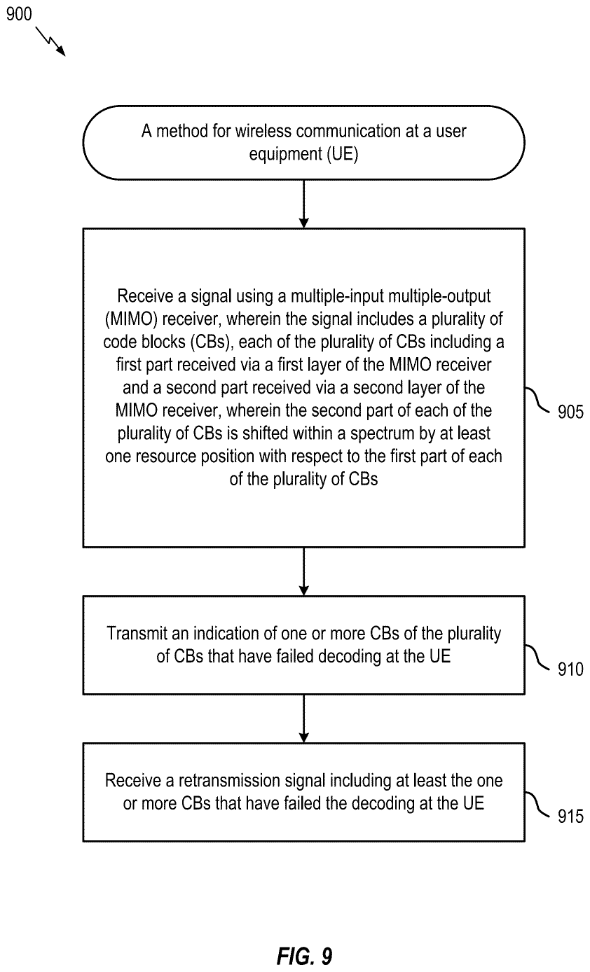

FIG. 9 shows an example of a method 900 of wireless communication at a user equipment (UE), such as a UE 104 of FIGS. 1 and 3.

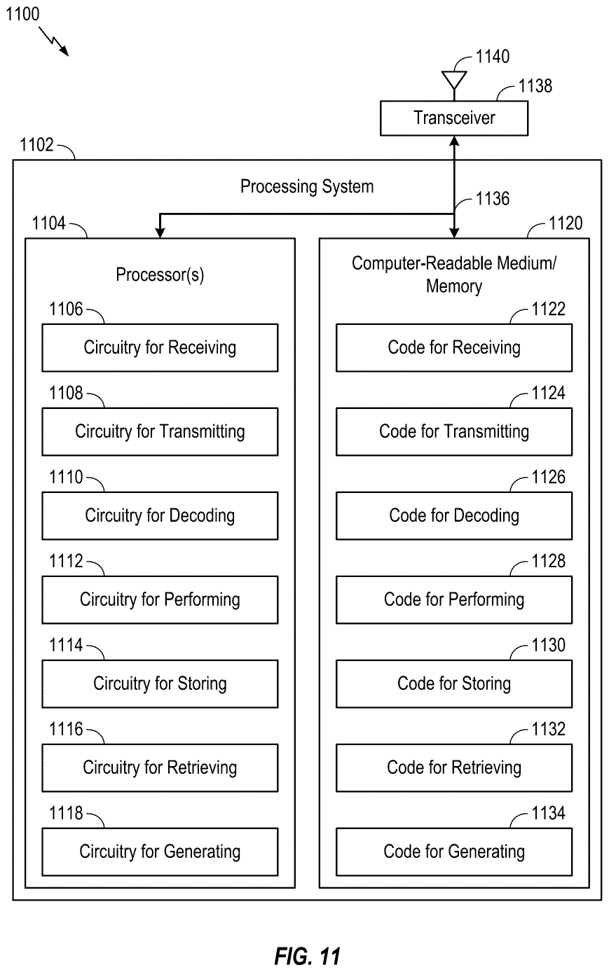

Method 900 begins at step 905 with receiving a signal using a multiple-input multiple-output (MIMO) receiver, wherein the signal includes a plurality of code blocks (CBs), each of the plurality of CBs including a first part received via a first layer of the MIMO receiver and a second part received via a second layer of the MIMO receiver, wherein the second part of each of the plurality of CBs is shifted within a spectrum by at least one resource position with respect to the first part of each of the plurality of CBs. In some cases, the operations of this step refer to, or may be performed by, circuitry for receiving and/or code for receiving as described with reference to FIG. 11.

Method 900 then proceeds to step 910 with transmitting an indication of one or more CBs of the plurality of CBs that have failed decoding at the UE. In some cases, the operations of this step refer to, or may be performed by, circuitry for transmitting and/or code for transmitting as described with reference to FIG. 11.

Method 900 then proceeds to step 915 with receiving a retransmission signal including at least the one or more CBs that have failed the decoding at the UE. In some cases, the operations of this step refer to, or may be performed by, circuitry for receiving and/or code for receiving as described with reference to FIG. 11.

In some aspects, the method 900 further includes decoding the one or more CBs included in the retransmission signal. In some cases, the operations of this step refer to, or may be performed by, circuitry for decoding and/or code for decoding as described with reference to FIG. 11.

In some aspects, the method 900 further includes performing interference cancellation for one or more other CBs of the plurality of CBs based on the decoding. In some cases, the operations of this step refer to, or may be performed by, circuitry for performing and/or code for performing as described with reference to FIG. 11.

In some aspects, the method 900 further includes decoding the one or more other CBs after performing the interference cancellation. In some cases, the operations of this step refer to, or may be performed by, circuitry for decoding and/or code for decoding as described with reference to FIG. 11.

In some aspects, the retransmission signal includes only the one or more CBs that have failed the decoding.

In some aspects, the retransmission signal includes the one or more CBs that have failed the decoding and one or more other CBs of the plurality of CBs to be decoded using interference cancellation at the UE after the one or more CBs are decoded.

In some aspects, the method 900 further includes receiving a grant for reception of the retransmission signal, wherein the grant includes an indication of the one or more CBs to be included in the retransmission signal. In some cases, the operations of this step refer to, or may be performed by, circuitry for receiving and/or code for receiving as described with reference to FIG. 11.

In some aspects, the retransmission signal is received using the MIMO receiver without shifting the second part of each CB of the one or more CBs within the spectrum with respect to the first part of the CB.

In some aspects, each of the one or more CBs in the retransmission signal includes a first part received via the first layer of the MIMO receiver and a second part received via the second layer of the MIMO receiver; and the second part of each of the one or more CBs in the retransmission signal is shifted within the spectrum by at least one resource position with respect to the first part of each of the one or more CBs in the retransmission signal.

In some aspects, the retransmission signal further comprises at least a head CB received via the second layer of the MIMO receiver, the head CB including data associated with the one or more CBs that have failed the decoding, no data, or data that is different than any data included in the plurality of CBs.

In some aspects, the method 900 further includes receiving an indication of whether the head CB includes data associated with the one or more CBs that have failed the decoding, no data, or data that is different than any data included in the plurality of CBs. In some cases, the operations of this step refer to, or may be performed by, circuitry for receiving and/or code for receiving as described with reference to FIG. 11.

In some aspects, the method 900 further includes storing, in memory, at least a portion of the received signal. In some cases, the operations of this step refer to, or may be performed by, circuitry for storing and/or code for storing as described with reference to FIG. 11.

In some aspects, the method 900 further includes retrieving at least the portion of the received signal from the memory. In some cases, the operations of this step refer to, or may be performed by, circuitry for retrieving and/or code for retrieving as described with reference to FIG. 11.

In some aspects, the method 900 further includes decoding at least the portion of the received signal as retrieved from the memory based on the one or more CBs included in the retransmission signal. In some cases, the operations of this step refer to, or may be performed by, circuitry for decoding and/or code for decoding as described with reference to FIG. 11.

In some aspects, at least the portion of the received signal that is stored comprises one or more other CBs of the plurality of CBs to be decoded using interference cancellation at the UE after the one or more CBs are decoded.

In some aspects, the method 900 further includes generating log-likelihood ratios (LLRs) for one or more subsequent CBs after the decoding for the one or more CBs has failed. In some cases, the operations of this step refer to, or may be performed by, circuitry for generating and/or code for generating as described with reference to FIG. 11.

In some aspects, the method 900 further includes performing decoding for the retransmission signal using linear minimum mean square error (LMMSE) or non-linear demodulation, the decoding being performed based on the LLRs. In some cases, the operations of this step refer to, or may be performed by, circuitry for performing and/or code for performing as described with reference to FIG. 11.

In some aspects, the method 900 further includes generating LLRs for one or more subsequent CBs after the decoding for the one or more CBs has failed. In some cases, the operations of this step refer to, or may be performed by, circuitry for generating and/or code for generating as described with reference to FIG. 11.

In some aspects, the method 900 further includes performing decoding for the retransmission signal using interference cancellation, the decoding being performed based on the LLRs. In some cases, the operations of this step refer to, or may be performed by, circuitry for performing and/or code for performing as described with reference to FIG. 11.

In some aspects, the interference cancellation is performed using hard decisions associated with the LLRs.

In some aspects, the method 900 further includes transmitting capability information indicating at least one of: whether the UE is capable of storing at least one of the received signal or LLRs associated with the received signal, one or more parameters indicating a buffering capability of the UE, whether the UE supports continuing decoding one or more other CBs of the received signal after the one or more CBs have failed decoding, a layer mapping scheme supported by the UE for reception of the retransmission signal, or whether the UE is capable of performing decoding of the plurality of CBs from both sides of the spectrum. In some cases, the operations of this step refer to, or may be performed by, circuitry for transmitting and/or code for transmitting as described with reference to FIG. 11.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

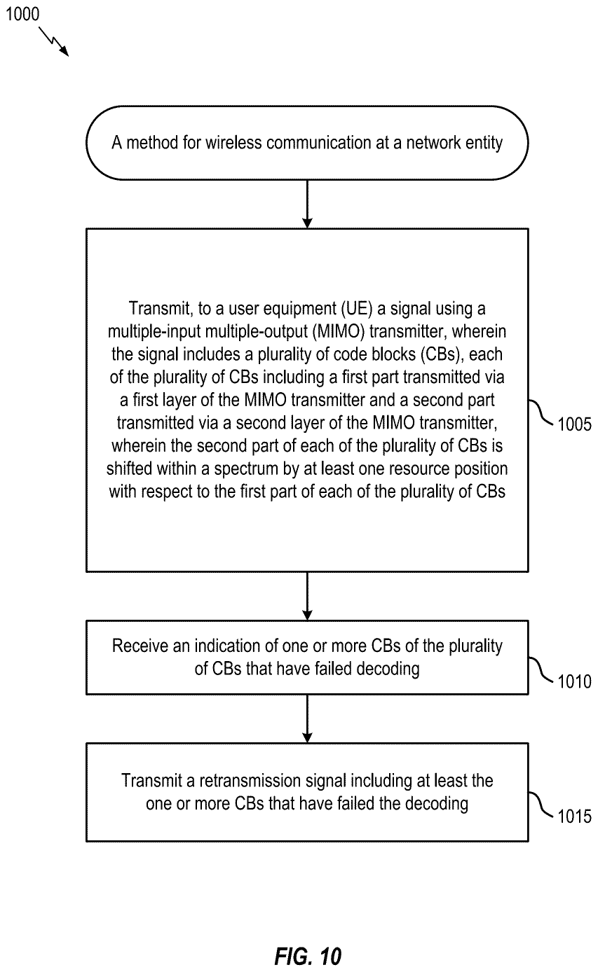

FIG. 10 shows an example of a method 1000 of wireless communication at a network entity, such as a BS 102 of FIGS. 1 and 3, or a disaggregated base station as discussed with respect to FIG. 2.

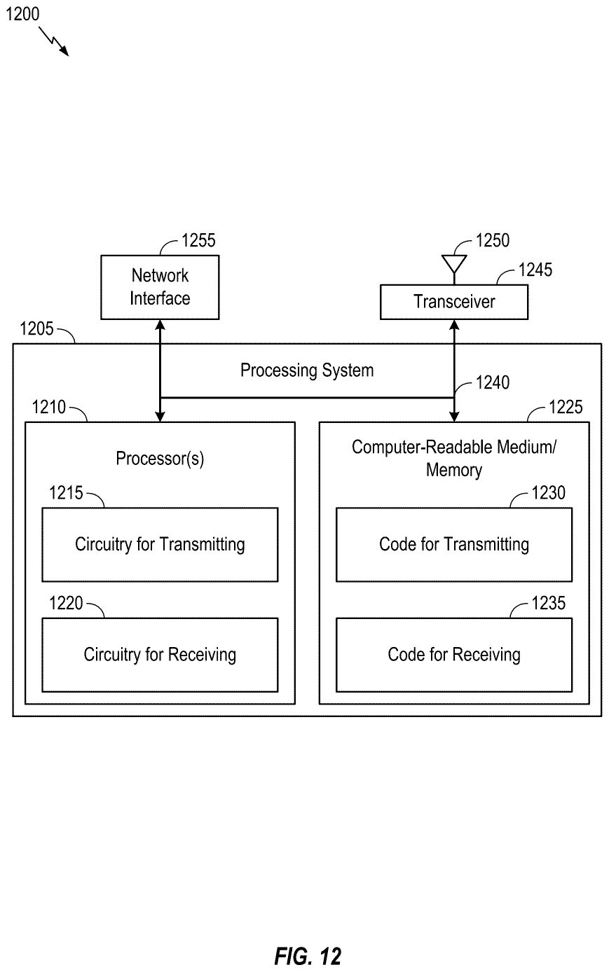

Method 1000 begins at step 1005 with transmitting, to a user equipment (UE) a signal using a multiple-input multiple-output (MIMO) transmitter, wherein the signal includes a plurality of code blocks (CBs), each of the plurality of CBs including a first part transmitted via a first layer of the MIMO transmitter and a second part transmitted via a second layer of the MIMO transmitter, wherein the second part of each of the plurality of CBs is shifted within a spectrum by at least one resource position with respect to the first part of each of the plurality of CBs. In some cases, the operations of this step refer to, or may be performed by, circuitry for transmitting and/or code for transmitting as described with reference to FIG. 12.

Method 1000 then proceeds to step 1010 with receiving an indication of one or more CBs of the plurality of CBs that have failed decoding. In some cases, the operations of this step refer to, or may be performed by, circuitry for receiving and/or code for receiving as described with reference to FIG. 12.

Method 1000 then proceeds to step 1015 with transmitting a retransmission signal including at least the one or more CBs that have failed the decoding. In some cases, the operations of this step refer to, or may be performed by, circuitry for transmitting and/or code for transmitting as described with reference to FIG. 12.

In some aspects, the retransmission signal includes only the one or more CBs that have failed the decoding.

In some aspects, the retransmission signal includes the one or more CBs that have failed the decoding and one or more other CBs of the plurality of CBs.

In some aspects, the method 1000 further includes transmitting a grant for reception of the retransmission signal, wherein the grant includes an indication of the one or more CBs to be included in the retransmission signal. In some cases, the operations of this step refer to, or may be performed by, circuitry for transmitting and/or code for transmitting as described with reference to FIG. 12.

In some aspects, the retransmission signal is transmitted using the MIMO transmitter without shifting the second part of each CB of the one or more CBs within the spectrum with respect to the first part of the CB.

In some aspects, each of the one or more CBs in the retransmission signal includes a first part transmitted via the first layer of the MIMO transmitter and a second part transmitted via the second layer of the MIMO transmitter; and the second part of each of the one or more CBs in the retransmission signal is shifted within the spectrum by at least one resource position with respect to the first part of each of the one or more CBs in the retransmission signal.

In some aspects, the retransmission signal further comprises at least a head CB received via the second layer of the MIMO transmitter, the head CB including data associated with the one or more CBs that have failed the decoding, no data, or data that is different than any data included in the plurality of CBs.

In some aspects, the method 1000 further includes transmitting an indication of whether the head CB includes data associated with the one or more CBs that have failed the decoding, no data, or data that is different than any data included in the plurality of CBs. In some cases, the operations of this step refer to, or may be performed by, circuitry for transmitting and/or code for transmitting as described with reference to FIG. 12.

In some aspects, the method 1000 further includes receiving capability information, wherein the retransmission signal is transmitted based on the capability information, the capability information indicating at least one of: whether the UE is capable of storing at least one of the transmitted signal or log likelihood ratios (LLRs) associated with the transmitted signal, one or more parameters indicating a buffering capability of the UE, whether the UE supports continuing decoding one or more other CBs of the transmitted signal after the one or more CBs have failed decoding, a layer mapping scheme supported by the UE for reception of the retransmission signal, or whether the UE is capable of performing decoding of the plurality of CBs from both sides of the spectrum. In some cases, the operations of this step refer to, or may be performed by, circuitry for receiving and/or code for receiving as described with reference to FIG. 12.

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Device(s)

FIG. 11 depicts aspects of an example communications device 1100. In some aspects, communications device 1100 is a user equipment, such as UE 104 described above with respect to FIGS. 1 and 3.

The communications device 1100 includes a processing system 1102 coupled to the transceiver 1138 (e.g., a transmitter and/or a receiver). The transceiver 1138 is configured to transmit and receive signals for the communications device 1100 via the antenna 1140, such as the various signals as described herein. The processing system 1102 may be configured to perform processing functions for the communications device 1100, including processing signals received and/or to be transmitted by the communications device 1100.

The processing system 1102 includes one or more processors 1104. In various aspects, the one or more processors 1104 may be representative of one or more of receive processor 358, transmit processor 364, TX MIMO processor 366, and/or controller/processor 380, as described with respect to FIG. 3. The one or more processors 1104 are coupled to a computer-readable medium/memory 1120 via a bus 1136. In certain aspects, the computer-readable medium/memory 1120 is configured to store instructions (e.g., computer-executable code) that when executed by the one or more processors 1104, cause the one or more processors 1104 to perform the method 900 described with respect to FIG. 9, or any aspect related to it. Note that reference to a processor performing a function of communications device 1100 may include one or more processors 1104 performing that function of communications device 1100.

In the depicted example, computer-readable medium/memory 1120 stores code (e.g., executable instructions), such as code for receiving 1122, code for transmitting 1124, code for decoding 1126, code for performing 1128, code for storing 1130, code for retrieving 1132, and code for generating 1134. Processing of the code for receiving 1122, code for transmitting 1124, code for decoding 1126, code for performing 1128, code for storing 1130, code for retrieving 1132, and code for generating 1134 may cause the communications device 1100 to perform the method 900 described with respect to FIG. 9, or any aspect related to it.

The one or more processors 1104 include circuitry configured to implement (e.g., execute) the code stored in the computer-readable medium/memory 1120, including circuitry such as circuitry for receiving 1106, circuitry for transmitting 1108, circuitry for decoding 1110, circuitry for performing 1112, circuitry for storing 1114, circuitry for retrieving 1116, and circuitry for generating 1118. Processing with circuitry for receiving 1106, circuitry for transmitting 1108, circuitry for decoding 1110, circuitry for performing 1112, circuitry for storing 1114, circuitry for retrieving 1116, and circuitry for generating 1118 may cause the communications device 1100 to perform the method 900 described with respect to FIG. 9, or any aspect related to it.

Various components of the communications device 1100 may provide means for performing the method 900 described with respect to FIG. 9, or any aspect related to it. For example, means for transmitting, sending or outputting for transmission may include transceivers 354 and/or antenna(s) 352 of the UE 104 illustrated in FIG. 3 and/or the transceiver 1138 and the antenna 1140 of the communications device 1100 in FIG. 11. Means for receiving or obtaining may include transceivers 354 and/or antenna(s) 352 of the UE 104 illustrated in FIG. 3 and/or the transceiver 1138 and the antenna 1140 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to the transceiver 1245 (e.g., a transmitter and/or a receiver) and/or a network interface 1255. The transceiver 1245 is configured to transmit and receive signals for the communications device 1200 via the antenna 1250, such as the various signals as described herein. The network interface 1255 is configured to obtain and send signals for the communications device 1200 via communication link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1225 via a bus 1240. In certain aspects, the computer-readable medium/memory 1225 is configured to store instructions (e.g., computer-executable code) that when executed by the one or more processors 1210, cause the one or more processors 1210 to perform the method 1000 described with respect to FIG. 10, or any aspect related to it. Note that reference to a processor of communications device 1200 performing a function may include one or more processors 1210 of communications device 1200 performing that function.

In the depicted example, the computer-readable medium/memory 1225 stores code (e.g., executable instructions), such as code for transmitting 1230 and code for receiving 1235. Processing of the code for transmitting 1230 and code for receiving 1235 may cause the communications device 1200 to perform the method 1000 described with respect to FIG. 10, or any aspect related to it.

The one or more processors 1210 include circuitry configured to implement (e.g., execute) the code stored in the computer-readable medium/memory 1225, including circuitry such as circuitry for transmitting 1215 and circuitry for receiving 1220. Processing with circuitry for transmitting 1215 and circuitry for receiving 1220 may cause the communications device 1200 to perform the method 1000 described with respect to FIG. 10, or any aspect related to it.

Various components of the communications device 1200 may provide means for performing the method 1000 described with respect to FIG. 10, or any aspect related to it. Means for transmitting, sending or outputting for transmission may include transceivers 332 and/or antenna(s) 334 of the BS 102 illustrated in FIG. 3 and/or the transceiver 1245 and the antenna 1250 of the communications device 1200 in FIG. 12. Means for receiving or obtaining may include transceivers 332 and/or antenna(s) 334 of the BS 102 illustrated in FIG. 3 and/or the transceiver 1245 and the antenna 1250 of the communications device 1200 in FIG. 12.

### EXAMPLE CLAUSES

Implementation examples are described in the following numbered clauses:

Clause 1: A method for wireless communication at a user equipment (UE), comprising: receiving a signal using a multiple-input multiple-output (MIMO) receiver, wherein the signal includes a plurality of code blocks (CBs), each of the plurality of CBs including a first part received via a first layer of the MIMO receiver and a second part received via a second layer of the MIMO receiver, wherein the second part of each of the plurality of CBs is shifted within a spectrum by at least one resource position with respect to the first part of each of the plurality of CBs; transmitting an indication of one or more CBs of the plurality of CBs that have failed decoding at the UE; and receiving a retransmission signal including at least the one or more CBs that have failed the decoding at the UE.

Clause 2: The method of Clause 1, further comprising: decoding the one or more CBs included in the retransmission signal; performing interference cancellation for one or more other CBs of the plurality of CBs based on the decoding of the one or more CBs included in the retransmission signal; and decoding the one or more other CBs after performing the interference cancellation.

Clause 3: The method of any one of Clauses 1-2, wherein the retransmission signal includes only the one or more CBs that have failed the decoding.

Clause 4: The method of any one of Clauses 1-3, wherein the retransmission signal includes the one or more CBs that have failed the decoding and one or more other CBs of the plurality of CBs to be decoded using interference cancellation at the UE after the one or more CBs in the retransmission signal are decoded.

Clause 5: The method of any one of Clauses 1-4, further comprising receiving a grant for reception of the retransmission signal, wherein the grant includes an indication of the one or more CBs to be included in the retransmission signal.

Clause 6: The method of any one of Clauses 1-5, wherein the retransmission signal is received using the MIMO receiver without shifting the second part of each CB of the one or more CBs within the spectrum with respect to the first part of the CB.

Clause 7: The method of any one of Clauses 1-6, wherein: each of the one or more CBs in the retransmission signal includes a first part received via the first layer of the MIMO receiver and a second part received via the second layer of the MIMO receiver; and the second part of each of the one or more CBs in the retransmission signal is shifted within the spectrum by at least one resource position with respect to the first part of each of the one or more CBs in the retransmission signal.

Clause 8: The method of Clause 7, wherein the retransmission signal further comprises at least a head CB received via the second layer of the MIMO receiver, the head CB including data associated with the one or more CBs that have failed the decoding, no data, or data that is different than any data included in the plurality of CBs.

Clause 9: The method of Clause 8, further comprising receiving an indication of whether the head CB includes data associated with the one or more CBs that have failed the decoding, no data, or data that is different than any data included in the plurality of CBs.

Clause 10: The method of any one of Clauses 1-9, further comprising: storing, in memory, at least a portion of the received signal; retrieving at least the portion of the received signal from the memory; and decoding at least the portion of the received signal as retrieved from the memory based on the one or more CBs included in the retransmission signal.

Clause 11: The method of Clause 10, wherein at least the portion of the received signal that is stored comprises one or more other CBs of the plurality of CBs to be decoded using interference cancellation at the UE after the one or more CBs in the retransmission signal are decoded.

Clause 12: The method of any one of Clauses 1-11, further comprising: generating log-likelihood ratios (LLRs) for one or more subsequent CBs after the decoding for the one or more CBs has failed; and performing decoding for the retransmission signal using linear minimum mean square error (LMMSE) or non-linear demodulation, the decoding for the retransmission signal being performed based on the LLRs.

Clause 13: The method of any one of Clauses 1-12, further comprising: generating LLRs for one or more subsequent CBs after the decoding for the one or more CBs has failed; and performing decoding for the retransmission signal using interference cancellation, the decoding for the retransmission signal being performed based on the LLRs.

Clause 14: The method of Clause 13, wherein the interference cancellation is performed using hard decisions associated with the LLRs.

Clause 15: The method of any one of Clauses 1-14, further comprising transmitting capability information indicating at least one of: whether the UE is capable of storing at least one of the received signal or LLRs associated with the received signal, one or more parameters indicating a buffering capability of the UE, whether the UE supports continuing decoding one or more other CBs of the received signal after the one or more CBs have failed decoding, a layer mapping scheme supported by the UE for reception of the retransmission signal, or whether the UE is capable of performing decoding of the plurality of CBs from both sides of the spectrum.

Clause 16: A method for wireless communication at a network entity, comprising: transmitting, to a user equipment (UE) a signal using a multiple-input multiple-output (MIMO) transmitter, wherein the signal includes a plurality of code blocks (CBs), each of the plurality of CBs including a first part transmitted via a first layer of the MIMO transmitter and a second part transmitted via a second layer of the MIMO transmitter, wherein the second part of each of the plurality of CBs is shifted within a spectrum by at least one resource position with respect to the first part of each of the plurality of CBs; receiving an indication of one or more CBs of the plurality of CBs that have failed decoding; and transmitting a retransmission signal including at least the one or more CBs that have failed the decoding.

Clause 17: The method of Clause 16, wherein the retransmission signal includes only the one or more CBs that have failed the decoding.

Clause 18: The method of any one of Clauses 16-17, wherein the retransmission signal includes the one or more CBs that have failed the decoding and one or more other CBs of the plurality of CBs.

Clause 19: The method of any one of Clauses 16-18, further comprising transmitting a grant for reception of the retransmission signal, wherein the grant includes an indication of the one or more CBs to be included in the retransmission signal.

Clause 20: The method of any one of Clauses 16-19, wherein the retransmission signal is transmitted using the MIMO transmitter without shifting the second part of each CB of the one or more CBs within the spectrum with respect to the first part of the CB.

Clause 21: The method of any one of Clauses 16-20, wherein: each of the one or more CBs in the retransmission signal includes a first part transmitted via the first layer of the MIMO transmitter and a second part transmitted via the second layer of the MIMO transmitter; and the second part of each of the one or more CBs in the retransmission signal is shifted within the spectrum by at least one resource position with respect to the first part of each of the one or more CBs in the retransmission signal.

Clause 22: The method of Clause 21, wherein the retransmission signal further comprises at least a head CB received via the second layer of the MIMO transmitter, the head CB including data associated with the one or more CBs that have failed the decoding, no data, or data that is different than any data included in the plurality of CBs.

Clause 23: The method of Clause 22, further comprising transmitting an indication of whether the head CB includes data associated with the one or more CBs that have failed the decoding, no data, or data that is different than any data included in the plurality of CBs.

Clause 24: The method of any one of Clauses 16-23, further comprising receiving capability information, wherein the retransmission signal is transmitted based on the capability information, the capability information indicating at least one of: whether the UE is capable of storing at least one of the transmitted signal or log likelihood ratios (LLRs) associated with the transmitted signal, one or more parameters indicating a buffering capability of the UE, whether the UE supports continuing decoding one or more other CBs of the transmitted signal after the one or more CBs have failed decoding, a layer mapping scheme supported by the UE for reception of the retransmission signal, or whether the UE is capable of performing decoding of the plurality of CBs from both sides of the spectrum.

Clause 25: An apparatus, comprising: at least one memory comprising executable instructions; and at least one processor configured to execute the executable instructions and cause the apparatus to perform a method in accordance with any combination of Clauses 1-24.

Clause 26: An apparatus, comprising means for performing a method in accordance with any combination of Clauses 1-24.

Clause 27: A non-transitory computer-readable medium comprising executable instructions that, when executed by at least one processor of an apparatus, cause the apparatus to perform a method in accordance with any combination of Clauses 1-24.

Clause 28: A computer program product embodied on a computer-readable storage medium comprising code for performing a method in accordance with any combination of Clauses 1-24.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for generating, means for transmitting, means for receiving, means for decoding, and means for determining may comprise one or more processors, such as one or more of the processors described above with reference to FIG. 14, and FIG. 15.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors configured to execute the computer-executable instructions and cause the apparatus to:
receive a signal using a multiple-input multiple-output (MIMO) receiver, wherein the signal includes a plurality of code blocks (CBs), each of the plurality of CBs including a first part received via a first layer of the MIMO receiver and a second part received via a second layer of the MIMO receiver, wherein the second part of each of the plurality of CBs is shifted within a spectrum by at least one resource position with respect to the first part of each of the plurality of CBs;
transmit an indication of one or more CBs of the plurality of CBs that have failed decoding at the UE; and
receive a retransmission signal including at least the one or more CBs that have failed the decoding at the UE.

2. The apparatus of claim 1, wherein the one or more processors are further configured to cause the apparatus to:
decode the one or more CBs included in the retransmission signal;
perform interference cancellation for one or more other CBs of the plurality of CBs based on the decoding of the one or more CBs included in the retransmission signal; and
decode the one or more other CBs after performing the interference cancellation.

3. The apparatus of claim 1, wherein the retransmission signal includes only the one or more CBs that have failed the decoding.

4. The apparatus of claim 1, wherein the retransmission signal includes the one or more CBs that have failed the decoding and one or more other CBs of the plurality of CBs to be decoded using interference cancellation at the UE after the one or more CBs in the retransmission signal are decoded.

5. The apparatus of claim 1, wherein the one or more processors are further configured to cause the apparatus to receive a grant for reception of the retransmission signal, wherein the grant includes an indication of the one or more CBs to be included in the retransmission signal.

6. The apparatus of claim 1, wherein the one or more processors are configured to cause the apparatus to receive the retransmission signal using the MIMO receiver without shifting the second part of each CB of the one or more CBs within the spectrum with respect to the first part of the CB.

7. The apparatus of claim 1, wherein:
each of the one or more CBs in the retransmission signal includes a first part received via the first layer of the MIMO receiver and a second part received via the second layer of the MIMO receiver; and
the second part of each of the one or more CBs in the retransmission signal is shifted within the spectrum by at least one resource position with respect to the first part of each of the one or more CBs in the retransmission signal.

8. The apparatus of claim 7, wherein the retransmission signal further comprises at least a head CB received via the second layer of the MIMO receiver, the head CB including data associated with the one or more CBs that have failed the decoding, no data, or data that is different than any data included in the plurality of CBs.

9. The apparatus of claim 8, wherein the one or more processors are further configured to cause the apparatus to receive an indication of whether the head CB includes data associated with the one or more CBs that have failed the decoding, no data, or data that is different than any data included in the plurality of CBs.

10. The apparatus of claim 1, wherein the one or more processors are further configured to cause the apparatus to:
store, in memory, at least a portion of the received signal; and
retrieve at least the portion of the received signal from the memory; and
decode at least the portion of the received signal as retrieved from the memory based on the one or more CBs included in the retransmission signal.

11. The apparatus of claim 10, wherein at least the portion of the received signal that is stored comprises one or more other CBs of the plurality of CBs to be decoded using interference cancellation at the UE after the one or more CBs in the retransmission signal are decoded.

12. The apparatus of claim 1, wherein the one or more processors are further configured to cause the apparatus to:
generate log-likelihood ratios (LLRs) for one or more subsequent CBs after the decoding for the one or more CBs has failed; and
perform decoding for the retransmission signal using linear minimum mean square error (LMMSE) or non-linear demodulation, the decoding for the retransmission signal being performed based on the LLRs.

13. The apparatus of claim 1, wherein the one or more processors are further configured to cause the apparatus to:
generate LLRs for one or more subsequent CBs after the decoding for the one or more CBs has failed; and
perform decoding for the retransmission signal using interference cancellation, the decoding for the retransmission signal being performed based on the LLRs.

14. The apparatus of claim 13, wherein the one or more processors are configured to cause the apparatus to perform the interference cancellation using hard decisions associated with the LLRs.

15. The apparatus of claim 1, wherein the one or more processors are further configured to cause the apparatus to transmit capability information indicating at least one of:
whether the UE is capable of storing at least one of the received signal or LLRs associated with the received signal;
one or more parameters indicating a buffering capability of the UE;
whether the UE supports continuing decoding one or more other CBs of the received signal after the one or more CBs have failed decoding;
a layer mapping scheme supported by the UE for reception of the retransmission signal; or
whether the UE is capable of performing decoding of the plurality of CBs from both sides of the spectrum.

16. An apparatus for wireless communication, comprising:
at least one memory comprising computer-executable instructions; and
one or more processors configured to execute the computer-executable instructions and cause the apparatus to:
transmit, to a user equipment (UE) a signal using a multiple-input multiple-output (MIMO) transmitter, wherein the signal includes a plurality of code blocks (CBs), each of the plurality of CBs including a first part transmitted via a first layer of the MIMO transmitter and a second part transmitted via a second layer of the MIMO transmitter, wherein the second part of each of the plurality of CBs is shifted within a spectrum by at least one resource position with respect to the first part of each of the plurality of CBs;
receive an indication of one or more CBs of the plurality of CBs that have failed decoding; and
transmit a retransmission signal including at least the one or more CBs that have failed the decoding.

17. The apparatus of claim 16, wherein the retransmission signal includes only the one or more CBs that have failed the decoding.

18. The apparatus of claim 16, wherein the retransmission signal includes the one or more CBs that have failed the decoding and one or more other CBs of the plurality of CBs.

19. The apparatus of claim 16, wherein the one or more processors are further configured to cause the apparatus to transmit a grant for reception of the retransmission signal, wherein the grant includes an indication of the one or more CBs to be included in the retransmission signal.

20. The apparatus of claim 16, wherein the one or more processors are configured to cause the apparatus to transmit the retransmission signal using the MIMO transmitter without shifting the second part of each CB of the one or more CBs within the spectrum with respect to the first part of the CB.

21. The apparatus of claim 16, wherein:
each of the one or more CBs in the retransmission signal includes a first part transmitted via the first layer of the MIMO transmitter and a second part transmitted via the second layer of the MIMO transmitter; and
the second part of each of the one or more CBs in the retransmission signal is shifted within the spectrum by at least one resource position with respect to the first part of each of the one or more CBs in the retransmission signal.

22. The apparatus of claim 21, wherein the retransmission signal further comprises at least a head CB received via the second layer of the MIMO transmitter, the head CB including data associated with the one or more CBs that have failed the decoding, no data, or data that is different than any data included in the plurality of CBs.

23. The apparatus of claim 22, wherein the one or more processors are further configured to cause the apparatus to transmit an indication of whether the head CB includes data associated with the one or more CBs that have failed the decoding, no data, or data that is different than any data included in the plurality of CBs.

24. The apparatus of claim 16, wherein the one or more processors are further configured to cause the apparatus to receive capability information, wherein the retransmission signal is transmitted based on the capability information, the capability information indicating at least one of:
whether the UE is capable of storing at least one of the transmitted signal or log likelihood ratios (LLRs) associated with the transmitted signal;
one or more parameters indicating a buffering capability of the UE;
whether the UE supports continuing decoding one or more other CBs of the transmitted signal after the one or more CBs have failed decoding;
a layer mapping scheme supported by the UE for reception of the retransmission signal; or
whether the UE is capable of performing decoding of the plurality of CBs from both sides of the spectrum.

25. A method for wireless communication at a user equipment (UE), comprising:
receiving a signal using a multiple-input multiple-output (MIMO) receiver, wherein the signal includes a plurality of code blocks (CBs), each of the plurality of CBs including a first part received via a first layer of the MIMO receiver and a second part received via a second layer of the MIMO receiver, wherein the second part of each of the plurality of CBs is shifted within a spectrum by at least one resource position with respect to the first part of each of the plurality of CBs;
transmitting an indication of one or more CBs of the plurality of CBs that have failed decoding at the UE; and
receiving a retransmission signal including at least the one or more CBs that have failed the decoding at the UE.

26. The method of claim 25, further comprising:
decoding the one or more CBs included in the retransmission signal;
performing interference cancellation for one or more other CBs of the plurality of CBs based on the decoding of the one or more CBs included in the retransmission signal; and
decoding the one or more other CBs after performing the interference cancellation.

27. The method of claim 25, wherein the retransmission signal includes only the one or more CBs that have failed the decoding.

28. The method of claim 25, wherein the retransmission signal includes the one or more CBs that have failed the decoding and one or more other CBs of the plurality of CBs to be decoded using interference cancellation at the UE after the one or more CBs in the retransmission signal are decoded.

29. The method of claim 25, further comprising receiving a grant for reception of the retransmission signal, wherein the grant includes an indication of the one or more CBs to be included in the retransmission signal.

30. A method for wireless communication at a network entity, comprising:
transmitting, to a user equipment (UE) a signal using a multiple-input multiple-output (MIMO) transmitter, wherein the signal includes a plurality of code blocks (CBs), each of the plurality of CBs including a first part transmitted via a first layer of the MIMO transmitter and a second part transmitted via a second layer of the MIMO transmitter, wherein the second part of each of the plurality of CBs is shifted within a spectrum by at least one resource position with respect to the first part of each of the plurality of CBs;
receiving an indication of one or more CBs of the plurality of CBs that have failed decoding; and
transmitting a retransmission signal including at least the one or more CBs that have failed the decoding.
